(19) United States
(12) Patent Application Publication
(10) Pub. No.: US 2006/0138780 A1
(43) Pub. Date: Jun. 29, 2006

(54) Modular wind turbine transmission

(76) Inventors: Peter Flamang, Bonheiden (BE); Warren Smook, Overijse (BE); Roger Bogaert, Dendermonde (BE)

Correspondence Address: YOUNG & THOMPSON, 745 SOUTH 23RD STREET, 2ND FLOOR, ARLINGTON, VA, 22202, US

(21) Appl. No.: 10/524,010

(22) PCT Filed: Aug. 8, 2003
(86) PCT No.: PCT/IB03/03596

§ 371 Date: Nov. 25, 2005

(30) Foreign Application Priority Data
Aug. 8, 2002 (GB) 0218401.8

(51) Int. Cl. F03D 9/00; H02P 9/04

(52) U.S. Cl. 290/55

(57) ABSTRACT

A wind turbine gear unit has a low speed gear module and a plurality of high speed gear modules wherein the low speed gear module is operable simultaneously to transmit torque to each of the high speed gear modules.

This invention relates to a wind turbine gear unit and in particular, but not exclusively, to an integrated rotor bearing wind turbine gear unit for multiple generators.

Torque transmission gear units for large multi-megawatt wind turbines currently face a range of design challenges. They have to be able to transmit the rotor power reliably, yet weigh as little as possible, cost as little as possible and be designed in such a way as to allow easy repair when required. Serviceability of the gearbox in the nacelle is very important in these large units because it is very costly to remove them, especially from offshore sites, to be repaired elsewhere. When serviceable in the nacelle, the design must be such as to reduce downtime to a minimum.

Another important design consideration is integration, implying that the gear unit must aim to take over as many structural tasks from the traditional wind turbine housing as possible. This means lower costs and lower overall weight. Furthermore the gear unit must be designed as compactly as possible, as this would again be beneficial for cost and weight.

In accordance with one aspect the present invention provides a wind turbine gear unit comprising a low speed gear module and a plurality of high speed gear modules wherein said low speed gear module is operable simultaneously to transmit torque to each of said high speed gear modules.

At least one of said high speed gear modules may be a multi-stage gear unit and said low speed gear module may be a multi-stage gear unit.

The gear unit(s) described below address the above issues and other issues by virtue of utilising:
i) Integrated rotor bearings.
ii) Modular design, mechanically and electrically.
iii) Multiple (small) generators.
iv) Gearbox housing used to transmit rotor loads to tower.
v) Absence of troublesome HSS (high speed shaft) couplings with generator(s)

Further aspects of the present invention will become apparent from the following description, given by way of example only, of embodiments of the invention in conjunction with the accompanying drawings in which:-

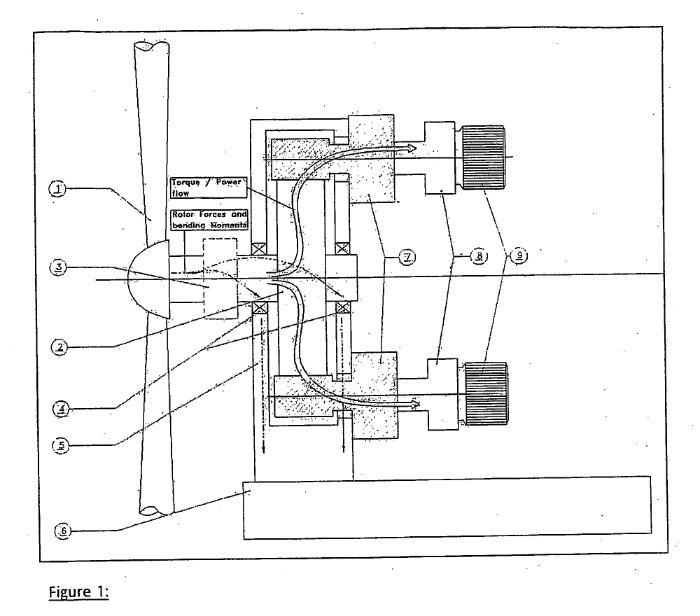

FIG. 1 shows a schematic diagram of a wind turbine gear unit according to the present invention; and

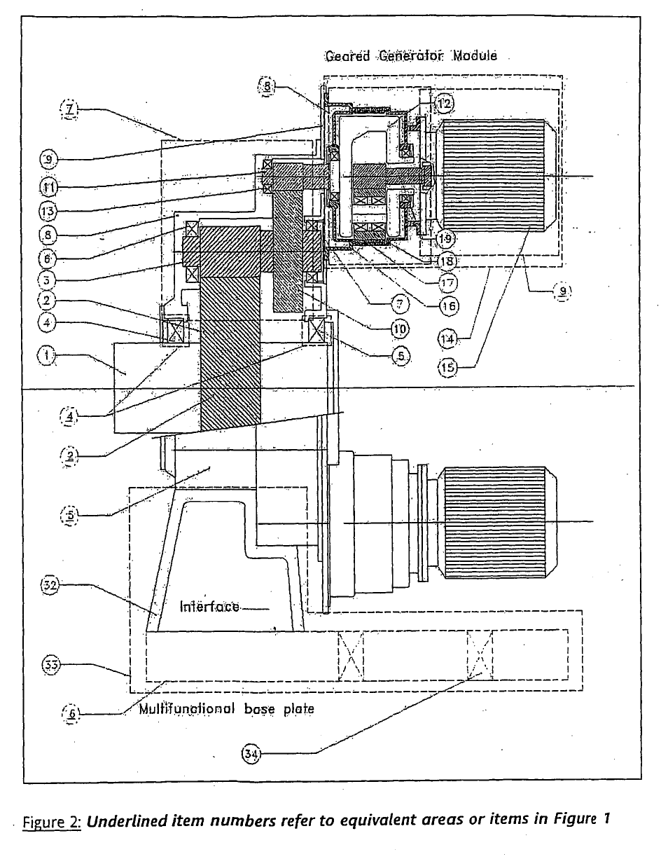

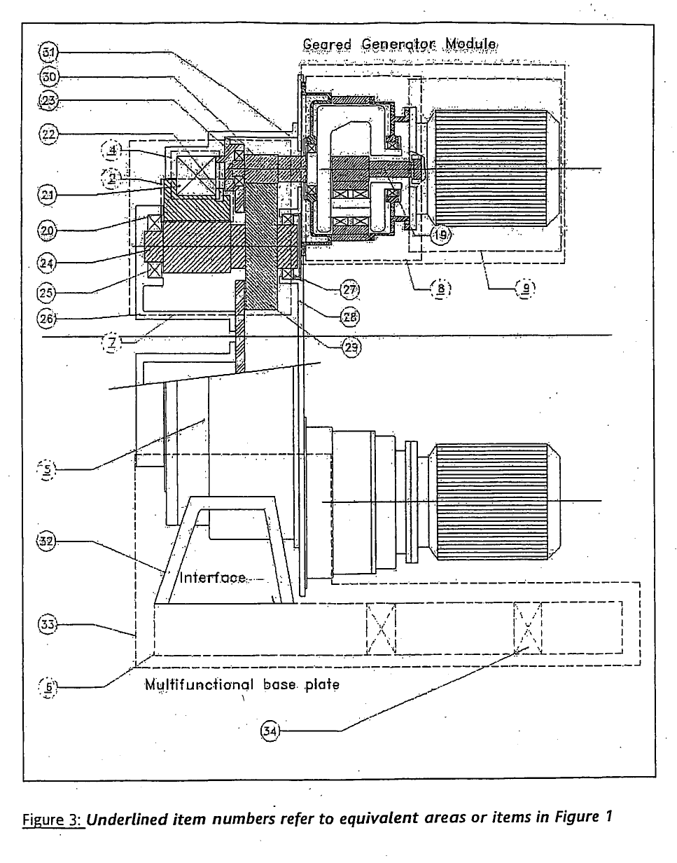

FIGS. 2 and 3 show in more detail variants of the invention.

In FIG. 1 a wind turbine rotor assembly (1) is coupled to the low speed gear element (2) of the gearbox, which may be either a bull gear or a ring wheel. The rotor is supported on an integrated bearing/bearings (4) which also locate the low speed gear in the gear housing (5). When using a ring wheel as the low speed gear element the bearing(s) (4) can for instance be situated on the outer diameter of the ring wheel.

The low speed gear drives several individual single or multiple stage low speed gear units (7) that may be comprised of planetary units, helical units or a combination of both. The secondary gear drive units (7) in turn drive several individual or multiple stage gear high speed gear units (8) that may be integrated or coupled to the generators (9).

The concept of the present invention may be characterised by:-
Power split to multiple generators. Rotor power is split in the first low speed stage resulting in completely independent mechanical torque transmission paths to the different generators.
Modularity—Several modules can be identified:
   A) The gearbox housing which doubles as a structural element that transfers the rotor forces and bending moments to the nacelle frame structure.
   B) Low speed module consisting of either a ring wheel or bull wheel supported on a bearing or bearings, coupled to several pinions that may drive single or multiple low speed stages.
   C) High speed module consisting of one or more helical or planetary stages (or a combination of both),and a generator. The high-speed modules could be identical to one another but do not have to be. Furthermore the generator can be integrated with the final high-speed stage or flanged onto the high-speed stage housing.
A control system allowing operation of the wind turbine without one or more generators.
Operation of the Wind turbine may be continued with one or more of the high-speed modules removed.
Disassembly in the nacelle: All modules are removable but the main gearbox housing can be left in place to fulfil its structural role even when the turbine is not operational. The housing can be integrated with the base plate of the nacelle (6).

FIGS. 2 and 3 show in more detail examples of possible practical executions of the system described above. (Note: Underlined item numbers refer to equivalent areas or items in FIG. 1)

In the construction shown in FIG. 2 the wind turbine rotor is attached to the low speed shaft (1), which turns the low speed wheel (2) and drives several pinion shafts (3). The low speed shaft is supported on two main bearings, (4) and (5), which also act as the rotor bearings.

The pinion shafts are supported by two bearings (6,7) which are housed in the main housing (8) and the planetary unit mounting plate, (9). A wheel (10) can be mounted on each pinion shaft which then meshes with a second pinion (11). The pinion is connected to the planet carrier (12) via a spline connection that may be either a loose or shrink fit. The pinion is supported on its other end by a bearing (13) housed in the main housing.

The geared generator module, (14), comprises a planetary gear unit and a flanged on or integrated generator (15). The module can be attached to the planetary unit mounting plate via a flange (16). The planetary unit comprises a rotating planet carrier, a stationary ring wheel (17) and rotating planets (18). The sun shaft from the planetary stage, (19), drives the generator via a spline coupling and is supported by the mesh on the one side and by the front generator bearing on the other.

In the construction shown in FIG. 3, the rotor is attached directly to a ring wheel (20) that is supported by one large main bearing (21). Alternatively two main bearings may be used. The bearing is axially constrained on the ring wheel by means of a split ring (22), and on it's outer diameter by part of the central bearing support plate, (23). The ring wheel drives several pinions (24) that are supported by two bearings, the first (25) which is housed in the front bearing support plate (26) and the second (27) in the planetary unit mounting plate (28). (Note this is a variant of item (9) in FIG. 2)

The front support bearing for the pinion (30) driven by wheel (29) is housed in the central bearing support that in turn is bolted to the main housing (31). The geared generator module can be identical in both of the constructions of FIGS. 2 and 3.

In both constructions, the main housing is fixed to the interface with the rest of the wind turbine's structure via supports (32) that form part of the main gearbox housing. The supports could be extended into a multifunctional “L” shaped base plate (33) that would support the gear unit and rotor as well as the yaw bearing (34) of the wind turbine nacelle.

Modularity is a significant aspect of the invention. By virtue of modularity the turbine rotor power is split at the first stage and forms independent paths to the generators. This implies that the turbine could operate with as many of these paths as is desired. This would also be beneficial in low wind situations or if one or more of the generator modules is removed for maintenance. Furthermore, the modules could be used in different wind turbine sizes. This has logistical advantages for the wind turbine manufacturer's service department.

A major advantage of splitting the rotor power into independent paths is that there are no load sharing problems between the individual pinions. The loads are balanced by equalising the power delivered by the different generators.

Integration is another important feature. Once assembled, the main housing could become part of the turbine structure and does not need to be removed again. The unit is designed in such a way as to allow the disassembly of all the gearbox internals. Furthermore, the wind turbine rotor bearings are integrated in the unit in both illustrated constructional versions, enabling compact overall design, lower weight and cost saving.

In conventional designs a flexible coupling has the burden of taking up misalignment between the generator shaft and gearbox HSS. In this design the sun shaft is directly coupled to the generator using a spline connection.

1-17. (canceled)

18. A wind turbine gear unit comprising a low speed gear module and a plurality of high speed gear modules wherein said low speed gear module is operable simultaneously to transmit torque to each of said high speed gear modules and whereby the rotor is supported by at least one bearing which is integrated in the housing of the low speed gear module.

19. The wind turbine gear unit according to claim 18, wherein at least one of said high speed gear modules is a multi-stage gear unit.

20. The wind turbine gear unit according to claim 18, wherein said low speed gear module is a multi-stage gear unit.

21. The wind turbine gear unit according to claim 18, wherein the low speed gear module comprises a housing adapted to transfer rotor forces and bending moments to a nacelle structure.

22. The wind turbine gear unit according to claim 21, wherein the housing is integrated with the base plate of the nacelle of the wind turbine.

23. The wind turbine gear unit according to claim 22, wherein the housing is used to transmit rotor loads to a tower supporting the nacelle of the wind turbine.

24. The wind turbine gear unit according to claim 23, wherein the base plate of the nacelle incorporates a yaw bearing of the nacelle, allowing the nacelle to rotate on the tower.

25. the wind turbine gear unit according to claim 24, wherein the housing is fixed to the wind turbine's structure via supports that form part of the housing and which are extended in a base plate that supports the gear unit and rotor, as well as the yaw bearing of the nacelle.

26. The wind turbine gear unit according to claim 18, wherein at least one of said high speed gear modules comprises a support housing which is selectively releasable from the housing of the low speed gear unit.

27. The wind turbine gear unit according to claim 18, wherein each high speed gear module housing provides support for bearings which rotatably support one or more rotatable components of that gear module.

28. The wind turbine gear unit according to claim 18, wherein at least one high speed gear module has an electrical generator associated therewith.

29. The wind turbine gear unit according to claim 28, wherein the or each said electrical generator receives input torque via only one high speed gear module.

30. The wind turbine gear unit according to claim 28, wherein a said generator and associated high speed gear module form a sub-assembly which is selectively removable from the low speed gear module.

31. The wind turbine gear unit according to claim 30, wherein said generator comprises a shaft rotatably coupled to the high speed gear module via a spline connection.

32. The wind turbine gear unit according to claim 18, wherein an intermediate stage gear module is provided between the low speed gear module and each high speed gear module.

33. The wind turbine gear unit according to claim 18, wherein a spline connection is provided between the low speed gear module and each high speed gear module.

34. The wind turbine gear unit according to claim 18 and which is of an integrated type in which a component of the low speed gear module acts as part of a main rotor bearing.

35. The wind turbine gear unit according to claim 18, wherein the low speed shaft is supported on one or more bearings which also act as rotor bearings.

36. The wind turbine gear unit according to claim 18, wherein all modules are removable whilst the housing is left in place to fulfill its structural role to support the rotor.

37. The wind turbine gear unit according to claim 18, and substantially as hereinbefore described with reference to the accompanying drawings.

38. A wind turbine assembly comprising a wind turbine gear unit according to claim 18, comprising a plurality of electrical generators and control means for selecting the number of generators operable to generate electricity.

39. A wind turbine assembly comprising a wind turbine gear unit according to claim 18, a plurality of electrical generators, a wind powered rotor assembly coupled to a low speed input of the low speed gear module, and a nacelle support structure, wherein the low speed gear unit comprises a housing which transmits forces from the rotor assembly to the nacelle support structure.

40. A wind turbine assembly comprising a wind turbine gear unit according to claim 18, a plurality of electrical generators, a wind powered rotor assembly coupled to a low speed input of the low speed gear module, and a nacelle support structure mounted on a supporting tower, wherein the low speed gear unit comprises a housing which transmits forces from the rotor assembly to the tower.

41. A wind turbine assembly comprising a wind turbine gear unit comprising a low speed gear module and a plurality of high speed gear modules to drive a plurality of generators, wherein said low speed gear module is operable simultaneously to transmit torque to each of said high speed gear modules; a wind powered rotor assembly coupled to a low speed input of the low speed gear module; and a nacelle support structure with a base plate incorporating a yaw bearing for mounting the nacelle on a tower, wherein the low speed gear unit comprises a housing that is integrated with the base plate of the nacelle.
